(19) United States
(12) Patent Application Publication
(10) Pub. No.: US 2025/0119501 A1
(43) Pub. Date: Apr. 10, 2025

(54) NON-TRANSITORY COMPUTER-READABLE STORAGE MEDIUM STORING PROGRAM, AND CONTROL METHOD

(71) Applicant: CANON KABUSHIKI KAISHA, Tokyo (JP)

(72) Inventor: NATSUMI KIKUTA, Tokyo (JP)

(21) Appl. No.: 18/906,249

(22) Filed: Oct. 4, 2024

(30) Foreign Application Priority Data
Oct. 10, 2023 (JP) 2023-175552

(51) Int. Cl. H04N 1/00

(52) U.S. Cl. CPC H04N 1/0048; H04N 1/00413; H04N 1/0044; H04N 1/00503

(57) ABSTRACT

A non-transitory computer-readable storage medium storing a program, which is able to operate on operating system, configured to cause a computer to execute a method, the method comprising: causing a computer of a second information processing apparatus having a second operating environment on a second OS running as the host OS and on the guest OS to execute, in a case where a data format of a file selected on the second file selection screen is not a predetermined data format, executing predetermined notification processing that is notification processing based on a fact that the data format of the file selected on the second file selection screen is not the predetermined data format, and is notification processing of displaying a notification screen representing that which data format is the predetermined data format.

### BACKGROUND OF THE INVENTION

### Field of the Invention

The present invention relates to a non-transitory computer-readable storage medium storing a program, and a control method.

### Description of the Related Art

Some programs running in an information processing apparatus such as a smartphone or a PC have a print function. For example, there is known a printing application program that performs a series of processes of searching for a printing apparatus on a LAN via Wi-Fi, converting a document file saved in a terminal into PDL data, generating a print job including print settings such as the number of copies, and transmitting the print job to the printing apparatus. Japanese Patent Laid-Open No. 2022-71664 discloses a method of printing a target document file by a printing apparatus suited to it.

### SUMMARY OF THE INVENTION

The present invention in one aspect provides a non-transitory computer-readable storage medium storing a program, which is able to operate on operating system, configured to cause a computer to execute a method, the method comprising: causing a computer of a first information processing apparatus having a first operating environment on a first OS running as a host OS but not on a guest OS to execute, executing processing for causing a first file management program corresponding to the first OS to display a first file selection screen, and executing predetermined processing based on a file selected on the first file selection screen; and causing a computer of a second information processing apparatus having a second operating environment on a second OS running as the host OS and on the guest OS to execute executing processing for causing a second file management program corresponding to the second OS to display a second file selection screen, in a case where a data format of a file selected on the second file selection screen is not a predetermined data format, executing predetermined notification processing that is notification processing based on a fact that the data format of the file selected on the second file selection screen is not the predetermined data format, and is notification processing of displaying a notification screen representing that which data format is the predetermined data format, and in a case where the data format of the file selected on the second file selection screen is the predetermined data format, executing processing based on a file selected on the second file selection screen.

According to the present invention, selection of a file of a data format not corresponding to a program by the user can be suppressed.

Further features of the present invention will become apparent from the following description of exemplary embodiments with reference to the attached drawings.

### BRIEF DESCRIPTION OF THE DRAWINGS

FIG. 1 is a block diagram showing the configuration of a communication system;

FIGS. 2A and 2B are views each showing the software configuration of an information processing apparatus;

FIG. 3 is a block diagram showing the configuration of a communication application;

FIG. 4 is a view showing a screen displayed by the communication application;

FIG. 5 is a flowchart showing processing executed by the communication application;

FIG. 6 is a flowchart showing processing executed by the first host OS;

FIG. 7 is a flowchart showing processing executed by the second host OS;

FIG. 8A and FIG. 8B are a view showing a file selection screen;

FIG. 9 is a view showing a screen displayed by the communication application;

FIG. 10 is a view showing a screen displayed by the communication application;

FIG. 11 is a view showing a screen displayed by the communication application; and

FIG. 12 is a view showing a file selection screen.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

Depending on the OS of an information processing apparatus, a file of a data format not corresponding to a program running on the OS is sometimes displayed. Even if the user selects such a file and designates a predetermined function, the predetermined function is not properly executed.

Some ingenuity is therefore required to prompt the user to select a file of a proper data format even when the user selects a file of a data format not corresponding to a program.

### First Embodiment

An information processing apparatus and a communication apparatus included in a communication system according to this embodiment will be described. In this embodiment, a smartphone is exemplified as the information processing apparatus, but the present invention is not limited to this and various kinds of apparatuses such as a portable terminal, a notebook PC, a tablet terminal, a Personal Digital Assistant (PDA), and a digital camera are applicable. As the communication apparatus, various kinds of apparatuses are applicable as long as they can perform wireless communication with the information processing apparatus. For example, concerning a printer, an inkjet printer, a full-color laser beam printer, a monochrome printer, and the like are applicable. Furthermore, not only a printer but also a scanner, a copying machine, a facsimile apparatus, a portable terminal, a smartphone, a laptop PC, a tablet terminal, a PDA, a digital camera, a music playback device, a television, a smart speaker, and the like are applicable. In addition, a multi-function peripheral having a plurality of functions such as a copying function, a FAX function, a print function, and a scanner function is also applicable. In this embodiment, the communication apparatus is assumed to be a multi-function printer having a print function and a scanner function.

### <Hardware Configuration of Each Apparatus>

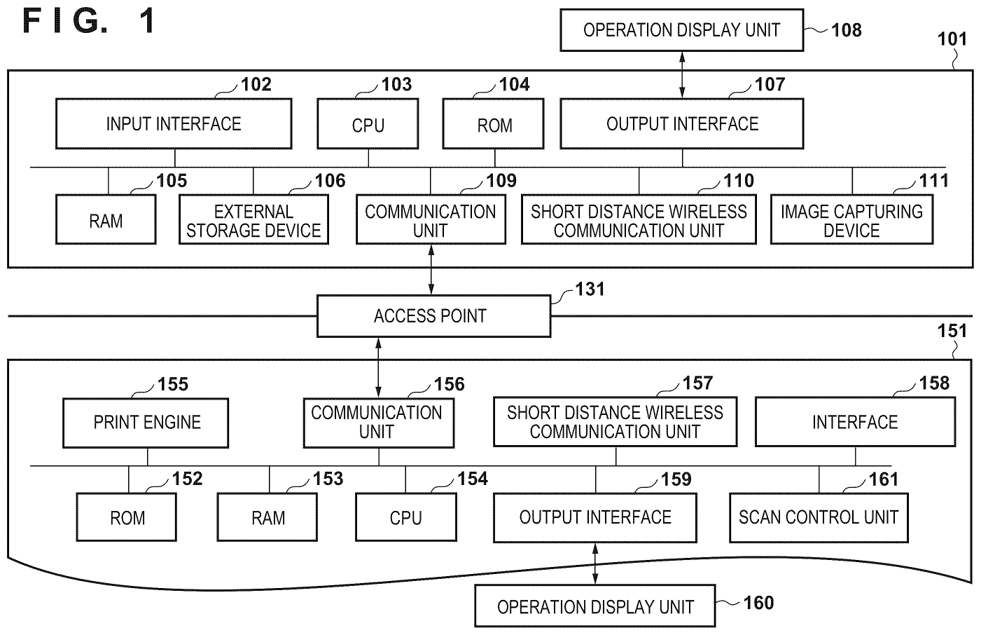

First, the configuration of an information processing apparatus included in the communication system according to this embodiment, and that of a communication apparatus communicable with the information processing apparatus will be explained with reference to the block diagram of FIG. 1. The following configuration will be exemplified in this embodiment, but functions are not specifically limited to those shown in FIG. 1.

An information processing apparatus 101 includes an input interface 102, a CPU 103, a ROM 104, a RAM 105, an external storage device 106, an output interface 107, an operation display unit 108, a communication unit 109, a short distance wireless communication unit 110, and an image capturing device 111.

The input interface 102 is an interface configured to accept a data input and an operation instruction from the user, and is formed by a physical keyboard, buttons, a touch panel, and the like. Note that the output interface 107 and the input interface 102 (to be described later) may have the same arrangement, and output of a screen and acceptance of an operation from the user may be done by the same arrangement.

The CPU 103 is a system control unit and controls the whole information processing apparatus 101.

The ROM 104 stores permanent data such as control programs to be executed by the CPU 103, data tables, and an embedded operating system (to be referred to as an OS hereinafter) program. In this embodiment, the control programs stored in the ROM 104 perform software execution control such as scheduling, task switch, and interrupt processing under the management of the embedded OS stored in the ROM 104. Note that in this embodiment, the OS that is held in the ROM 104 and runs on the information processing apparatus 101 is assumed to be an Android® OS provided by Google Inc. or a Chrome® OS provided by Google Inc. When the OS running on the information processing apparatus 101 is the Chrome OS, the ROM 104 holds even a virtual Android OS for operating an Android OS application program (to be described later) on the information processing apparatus 101. Note that an application program will be described as an application hereinafter.

The RAM 105 is formed by a Static Random Access Memory (SRAM) or the like, which needs a backup power supply. Note that the RAM 105 can store important data such as program control variables without volatilization because the data are held by a primary battery (not shown) for data backup. In addition, a memory area for storing setting information of the information processing apparatus 101, management data of the information processing apparatus 101, and the like is also provided in the RAM 105. Furthermore, the RAM 105 is also used as the main memory and work memory of the CPU 103.

The external storage device 106 includes an application program (to be described as a communication application hereinafter) having a function of communicating with a communication apparatus 151. Note that the communication application is, for example, an application having a print function for causing the communication apparatus 151 to execute printing, and a scan function for causing the communication apparatus 151 to execute scanning. However, the communication application is not limited to this form, and may be an application having either of the print function and the scan function, or an application having another function. The external storage device 106 also has various programs such as a print information generation program for generating print information interpretable by the communication apparatus 151, and an information transmission/reception control program for performing transmission/reception to/from the communication apparatus 151 connected via the communication unit 109. The external storage device 106 saves various kinds of information to be used by the programs. The external storage device 106 also saves image data obtained from another information processing apparatus or the Internet via the communication unit. Note that the communication application in this embodiment is an application for the Android OS.

The output interface 107 is an interface that performs control for causing the operation display unit 108 to perform display of data and notification of the state of the information processing apparatus 101.

The operation display unit 108 is formed by an LED (Light-Emitting Diode), an LCD (Liquid Crystal Display), or the like, and performs display of data and notification of the state of the information processing apparatus 101. Note that a soft keyboard including keys such as numerical input keys, a mode setting key, an OK key, a cancel key, and a power key may be provided on the operation display unit 108 so that an input from the user is accepted via the operation display unit 108.

The communication unit 109 is configured to be connected to an apparatus such as the communication apparatus 151 to execute data communication. For example, the communication unit 109 can be connected to an access point (not shown) in the communication apparatus 151. When the communication unit 109 and the access point in the communication apparatus 151 are connected to each other, the information processing apparatus 101 and the communication apparatus 151 can communicate with each other. The access point will be sometimes represented as an AP hereinafter. Note that the communication unit 109 may directly communicate with the communication apparatus 151 by wireless communication, or may communicate via an access point 131 existing outside the information processing apparatus 101 and the communication apparatus 151. As the wireless communication method, the IEEE802.11 communication standard is used in this embodiment. Note that the IEEE802.11 communication standard is Wi-Fi®.

As the access point 131, for example, a device such as a wireless LAN router can be used. Note that in this embodiment, a method of connecting the information processing apparatus 101 and the communication apparatus 151 directly without intervention of the external access point will be referred to as a direct connection method hereinafter. In addition, a method of connecting the information processing apparatus 101 and the communication apparatus 151 via the external access point 131 will be referred to as an infrastructure connection method hereinafter.

The short distance wireless communication unit 110 is configured to wirelessly connect to an apparatus such as the communication apparatus 151 at a short distance and execute data communication. The short distance wireless communication unit 110 performs communication by a communication method different from that of the communication unit 109. The short distance wireless communication method used by the short distance wireless communication unit 110 is, for example, Bluetooth® or NFC (Near Field Communication). Bluetooth may be Bluetooth Classic or Bluetooth Low Energy. The short distance wireless communication unit 110 can connect to a short distance wireless communication unit 157 in the communication apparatus 151.

The image capturing device 111 is a device that converts an image captured by an image sensor into digital data. The digital data is temporarily stored in the RAM 105. Then, the digital data is converted into a predetermined image format by a program executed by a CPU 154, and saved as image data in the external storage device 106.

The ROM 152 stores permanent data such as control programs to be executed by the CPU 154, data tables, and an OS program.

The communication apparatus 151 includes a ROM 152, a RAM 153, the CPU 154, a print engine 155, a communication unit 156, the short distance wireless communication unit 157, an input interface 158, an output interface 159, an operation display unit 160, and a scan control unit 161. When a connection mode (communication mode) is set, the communication apparatus 151 can operate in the set connection mode.

The communication unit 156 is configured to allow the communication apparatus 151 to communicate with another apparatus. In this embodiment, the communication unit 156 performs communication in accordance with the IEEE802.11 communication standard. The communication unit 156 includes, as an access point in the communication apparatus 151, an access point for performing connection to an apparatus such as the information processing apparatus 101. Note that the access point can be connected to the communication unit 109 of the information processing apparatus 101. Note also that the communication unit 156 may directly communicate with the information processing apparatus 101 by wireless communication, or may communicate with the information processing apparatus 101 via the access point 131. The communication unit 156 may include hardware functioning as an access point, or operate as an access point by software for causing the communication unit 156 to function as an access point. Note that in this embodiment, the communication unit 156 and the short distance wireless communication unit 157 are implemented by one wireless chip. That is, in this embodiment, a combo chip corresponding to both a communication function based on the IEEE802.11 communication standard and a communication function based on the short distance wireless communication method is used. However, the present invention is not limited to this form, and the communication unit 156 and the short distance wireless communication unit 157 may be implemented by separate wireless chips.

The RAM 153 is formed by a DRAM or the like that needs a backup power supply. Note that the RAM 153 can store important data such as program control variables without volatilization because the data are held by supplying power (not shown) for data backup. Furthermore, the RAM 153 is used as the main memory and work memory of the CPU 154, functions as a reception buffer for temporarily saving print information received from the information processing apparatus 101 or the like, and saves various kinds of information.

The ROM 152 stores permanent data such as control programs to be executed by the CPU 154, data tables, and an OS program. In this embodiment, the respective control programs stored in the ROM 152 perform software execution control such as scheduling, task switch, and interrupt processing under the management of the embedded OS stored in the ROM 152. In addition, a memory area that stores data necessary to be held even when no power is supplied, such as setting information of the communication apparatus 151 and management data of the communication apparatus 151, is also provided in the ROM 152.

The CPU 154 is a system control unit, and controls the overall communication apparatus 151.

Based on the information saved in the RAM 153 or a print job received from the information processing apparatus 101 or the like, the print engine 155 forms an image on a print medium such as a paper sheet using a printing material such as ink and outputs the print result. At this time, the print job transmitted from the information processing apparatus 101 or the like has a large transmission data amount, and high-speed communication is required. Thus, the print engine 155 receives the print job via the communication unit 156 capable of performing communication at a higher speed than the short distance wireless communication unit 157.

The short distance wireless communication unit 157 is configured to wirelessly connect to an apparatus such as the information processing apparatus 101 at a short distance and execute data communication. The short distance wireless communication unit 157 performs communication by a communication method different from that of the communication unit 156. The short distance wireless communication method used in the short distance wireless communication unit 157 is, for example, Bluetooth® or NFC. Bluetooth may be Bluetooth Classic or Bluetooth Low Energy. The short distance wireless communication unit 157 can connect to the short distance wireless communication unit 110.

The input interface 158 is an interface configured to accept a data input and an operation instruction from the user, and is formed by a physical keyboard, buttons, a touch panel, and the like. Note that the output interface 159 and the input interface 158 (to be described later) may have the same arrangement, and output of a screen and acceptance of an operation from the user may be done by the same arrangement. The output interface 159 is an interface that performs control for causing the operation display unit 160 to perform display of data and notification of the state of the communication apparatus 151.

The operation display unit 160 is formed by a display unit such as an LED (Light-Emitting Diode) or an LCD (Liquid Crystal Display), and performs display of data and notification of the state of the communication apparatus 151. Note that a soft keyboard including keys such as numerical input keys, a mode setting key, an OK key, a cancel key, and a power key may be provided on the operation display unit 160 so that an input from the user is accepted via the operation display unit 160.

The scan control unit 161 includes an image sensor unit (reading unit) that executes scanning of a document set on a document table or an ADF (not shown). Note that the image sensor unit includes a light source configured to irradiate a document with light, and an image sensor having an array of elements configured to read the reflected light and photoelectrically convert it. The scan control unit 161 obtains image data by analog/digital (A/D)-converting an analog electric signal obtained by reading a document by the image sensor unit. The scan control unit 161 also includes a circuit configured to perform direct memory access (DMA) transfer in order to store obtained image data in the RAM 153.

### <Software Configuration of Information Processing Apparatus 101>

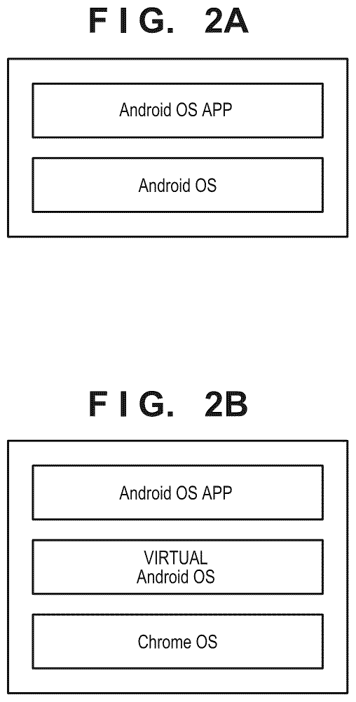

Next, the software configuration of the information processing apparatus 101 according to this embodiment will be explained. FIG. 2A shows an example of the software configuration of the information processing apparatus 101 when a host OS running in the information processing apparatus 101 is the Android OS. In this form, an application for the Android OS runs on the Android OS. In this form, the software configuration of the information processing apparatus 101 does not include the Chrome OS. An environment where an OS running on the lowest layer of the information processing apparatus 101 is the Android OS (not the Chrome OS), like this form, will be called the first environment. The first environment is, for example, an environment where a host OS is installed in the information processing apparatus 101 but no guest OS is installed, and a communication application runs on the host OS. Also, the first environment is, for example, an environment where both a host OS and a guest OS are installed in the information processing apparatus 101, and a communication application runs on the host OS and operates without the intervention of the guest OS (does not run on the guest OS). Note that the host OS stands for a host operating system, and the guest OS stands for a guest operating system.

FIG. 2B shows an example of the software configuration of the information processing apparatus 101 when a host OS running in the information processing apparatus 101 is the Chrome OS. In this form, a virtual Android OS serving as a virtual OS runs on the Chrome OS. An application for the Android OS runs on the virtual Android OS. An environment where an OS running on the lowest layer of the information processing apparatus 101 is the Chrome OS and the virtual Android OS runs on the Chrome OS, like this form, will be called the second environment. Note that in this embodiment, a virtual OS is a program for operating, on a host OS, an application not corresponding to the host OS, and is a guest OS. Note that the virtual OS may be a whole existing OS such as the Android OS, an OS obtained by omitting some modules from a whole existing OS, or a program created separately from an existing OS. The virtual OS is implemented by, for example, a virtualization technique such as a Virtual Machine system or a container system. Note that in the following description, a host OS (Android OS) in the first environment will be sometimes called the first OS, and a host OS (Chrome OS) in the second environment will be sometimes called the second host OS.

A problem generated when an application for the Android OS is operated in the second environment will be explained below. An example in which the above-mentioned communication application is installed in both the first and second environments and executed will also be explained. Note that as the communication application, a printing application that communicates with the communication apparatus 151 having the print function and provides a function of causing the communication apparatus 151 to execute printing of data such as a document or an image will be exemplified. An application developed in conformity with the Android OS so as to execute the application on the Android OS will be sometimes called an Android application.

When the communication application serving as an application for the Android OS is operated in the second environment, if the print function of the communication application is executed, the communication application instructs the guest OS to execute display of a file. In addition, the communication application instructs the guest OS about a data format corresponding to the print function. Upon accepting the instruction from the communication application, the guest OS transmits, to the Chrome OS serving as the host OS, an instruction similar to the instruction accepted from the communication application. In response to this, the Chrome OS displays, on the screen by an OS filer (to be described later), a list of files of the data format corresponding to the print function of the communication application. In some cases, the Chrome OS displays, for example, an interface capable of displaying a file of a data format different from the data format instructed from the communication application. For example, when the user operates the interface to display a file of a data format not corresponding to the communication application, the user may select the file of the data format not corresponding to the print function of the communication application. If the user selects the file of the data format not corresponding to the print function of the communication application and designates the print function, the communication application cannot properly execute the print function. For example, an error or a timeout may occur in processing for executing the print function by a communication application 300. To prevent this, ingenuity is required to prompt the user to select a file of a proper data format even when the user selects a file of a data format not corresponding to the communication application.

An application program runnable on the OS in this embodiment causes the computer of the information processing apparatus 101 having the second operating environment on the second host OS and on the guest OS to execute the following processing. The program causes the computer to execute the second display control of causing the second file management program corresponding to the guest OS to display the second file selection screen. When the data format of a file selected on the second file selection screen does not correspond to the function of the communication application, the program causes the computer to execute notification of executing notification processing based on the data format not corresponding to the function of the communication application. In contrast, when the data format of a file selected on the second file selection screen corresponds to the function of the communication application, the program causes the computer to execute processing based on the file selected on the second file selection screen. Even when a file of a data format not corresponding to the communication application is selected, the program can prompt the user to select a file of a proper data format.

### Configuration of Communication Application

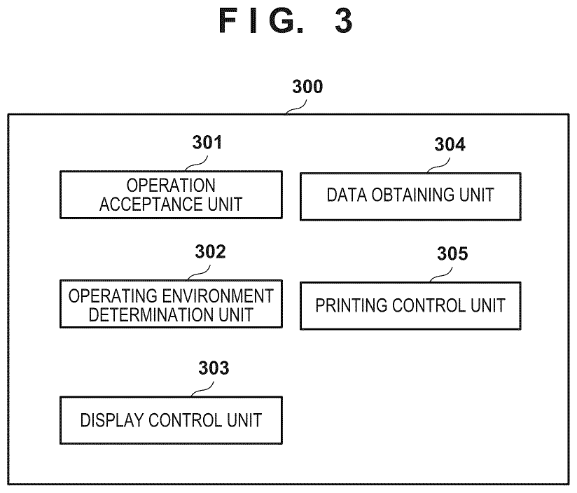

The communication application will be described below with reference to FIG. 3. FIG. 3 shows the configuration of the communication application of the information processing apparatus 101 that is stored in the ROM 104, the external storage device 106, or the like. The communication application is an application having, for example, the print function of causing the communication apparatus 151 functioning as a printer or a printing apparatus to print data such as a document file or an image file in the information processing apparatus 101, which will be described later. The communication application also has a function of loading, into the information processing apparatus 101, image data, document data, or the like scanned by the communication apparatus 151.

The communication application 300 includes an operation acceptance unit 301, an operating environment determination unit 302, a display control unit 303, an image data obtaining unit 304, a printing control unit 305, and the like. Each program module is executed by the CPU 103 to implement its function. In this embodiment, the communication application 300 uses the operation acceptance unit 301 to accept an operation performed on the operation display unit 108. The communication application 300 uses the operating environment determination unit 302 to determine which of the first environment provided by the Android OS and the second environment provided by the virtual Android OS built on the Chrome OS is the current operating environment of the communication application 300. This determination can be made based on a response obtained by an inquiry to the OS or with reference to a predetermined storage portion.

The display control unit 303 performs control of display on the operation display unit 108 by the communication application 300. For example, when the user presses the icon of the communication application 300 displayed on the operation display unit 108 of the information processing apparatus 101, the display control unit 303 displays a home screen (to be described later) on the operation display unit 108. For example, when the communication application 300 obtains a file selected by the user from the second host OS of the information processing apparatus 101 and the obtained file does not have a predetermined data format, the display control unit 303 performs display control to display a predetermined notification, which will be described later.

The data obtaining unit 304 obtains data such as a document file or an image file from the OS of the information processing apparatus 101. The data obtaining unit 304 may obtain data such as a document file or an image file from a data providing source such as a cloud server. The data obtained by the data obtaining unit 304 is transmitted to the communication apparatus 151 to execute printing under the control of the printing control unit 305, or is saved in the external storage device 106 of the information processing apparatus 101 or the like.

The printing control unit 305 performs processing of transmitting printing target data to the connected communication apparatus 151 and printing the data. The printing control unit 305 may perform, for example, processing of converting printing target data into a predetermined data format. Printing target data is, for example, data obtained from the OS by the data obtaining unit 304. Alternatively, printing target data may be data such as a document file or an image file saved when the communication application 300 is activated. Alternatively, printing target data may be data obtained from a cloud server, the communication apparatus 151, or the like. Printing target data may be data obtained from another data source. Note that in the following description, processing described as processing executed by a configuration in the communication application shown in FIG. 3 is accurately processing implemented by reading out, to the RAM 105, the communication application 300 stored in the ROM 104 or the like, and executing the communication application 300 by the CPU 103.

### Display Screen of Communication Application

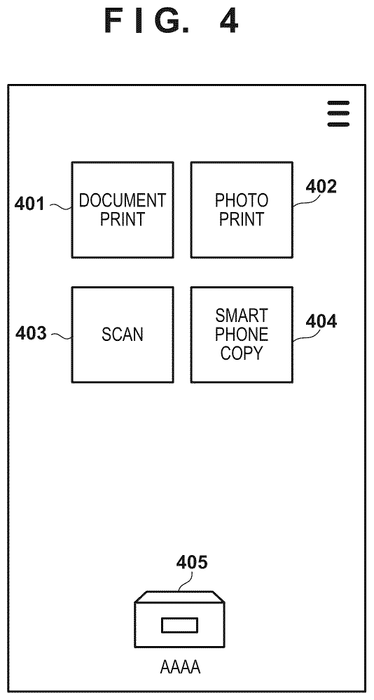

FIG. 4 is a view showing an example of the home screen of the communication application 300 according to this embodiment. The home screen of the communication application 300 may be displayed by, for example, operating by the user an icon that is displayed on the operation display unit 108 of the information processing apparatus 101 and represents the communication application 300. The home screen displayed by the communication application 300 displays interfaces 401 to 404 capable of accepting an instruction to execute each function provided by the communication application 300. The communication application 300 according to this embodiment has, for example, a print job transmission function, a scan job transmission function, and a copy job transmission function. The print job transmission function is, for example, a function of transmitting, to the communication apparatus 151, a print job for causing the communication apparatus 151 to print image data selected by the user on the information processing apparatus 101. The scan job transmission function is, for example, a function of transmitting, to the communication apparatus 151, a scan job for causing the communication apparatus 151 to execute scanning, and transmitting image data obtained by scanning to the information processing apparatus 101. The copy job transmission function is, for example, a function of transmitting, to the communication apparatus 151, a print job for causing the communication apparatus 151 to print image data captured by the information processing apparatus 101.

The document print button 401 is, for example, an interface capable of accepting an instruction to execute the print job transmission function (document print function) of a document file. The user can press the document print button 401 to select a document file to be printed on the information processing apparatus 101, and perform print settings and a print execution instruction.

The document file is a file of a data format corresponding to the print job transmission function. Data formats (data formats printable by the communication application 300 using the document print function) corresponding to document files are, for example, a data format corresponding to Portable Document Format (to be referred to as PDF hereinafter), a data format corresponding to Microsoft Word, a data format corresponding to Microsoft Excel, and a data format corresponding to Microsoft PowerPoint. Note that the data formats are not limited to those described above and may be other data formats.

The photo print button 402 is, for example, an interface capable of accepting an instruction to execute the print job transmission function (photo print function) of an image file. The image file is a file of a data format corresponding to the print job transmission function.

For example, when the communication application 300 runs in the first environment, data formats corresponding to image files are a data format corresponding to Joint Photographic Experts Group (to be referred to as JPEG hereinafter), a data format corresponding to Graphics Interchange Format (to be referred to as GIF hereinafter), a data format corresponding to Portable Network Graphics (to be referred to as PNG hereinafter), a data format corresponding to Microsoft Windows Bitmap Image (to be referred to as BMP hereinafter), and a data format corresponding to High Efficiency Image File Format (to be referred to as HEIF hereinafter).

For example, when the communication application 300 runs on the second OS, data formats corresponding to image files (data formats printable by the photo print function of the communication application 300) are a data format corresponding to JPEG, a data format corresponding to GIF, a data format corresponding to PNG, and a data format corresponding to BMP. Note that the data formats are not limited to those described above and may be other data formats.

The scan button 403 is, for example, an interface capable of accepting execution of the above-described scan job transmission function. The copy button 404 is, for example, an interface capable of accepting an instruction to execute the above-described copy job transmission function. An icon 405 may be, for example, an icon representing the communication apparatus 151 connected to the information processing apparatus 101. The icon 405 may display, for example, identification information (SSID or device name) of the communication apparatus 151 connected to the information processing apparatus 101. Note that the display of the home screen of the communication application 300 is not limited to the interfaces shown in FIG. 4, and other interfaces or the like may be displayed.

### Processing of Communication Application

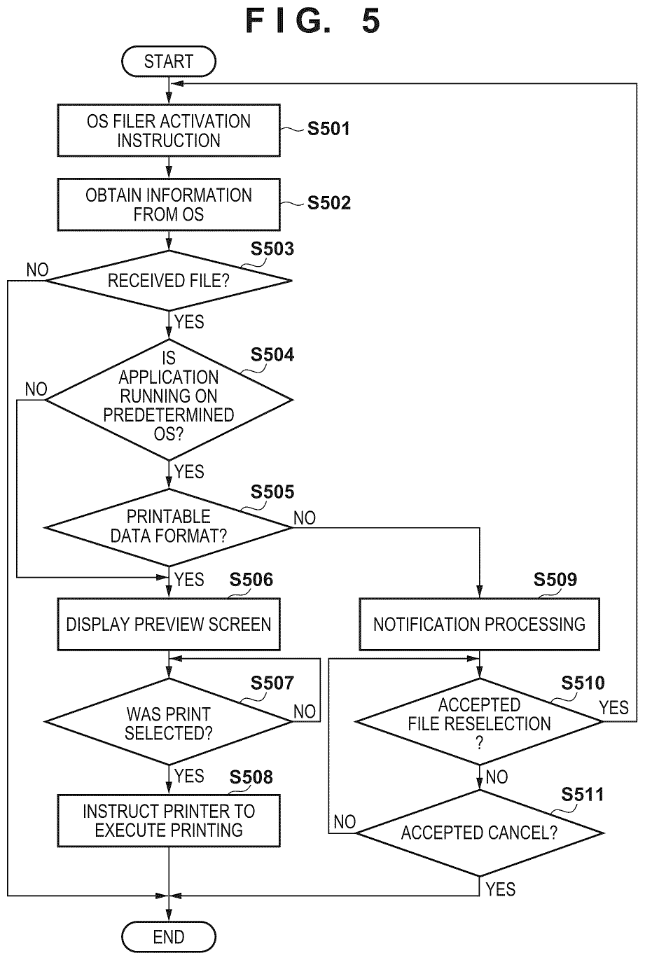

FIG. 5 is a flowchart showing an example of an operation executed by the communication application 300 according to this embodiment. In this flowchart, processing executed by the communication application 300 is implemented by, for example, deploying, in the RAM 105, a control program stored in a memory such as the ROM 104 and executing it by the CPU 103. The processing in FIG. 5 may be started based on, for example, pressing of the document print button 401 by the user on the home screen displayed by the above-described communication application 300. The processing in FIG. 5 will be explained separately for a case where the communication application 300 runs in the first environment and a case where the communication application 300 runs in the second environment.

### Processing when Communication Application Runs in First Environment

First, processing when the communication application 300 runs in the first environment will be explained.

In step S501, the communication application 300 designates a data format (data format printable by the communication application 300 using the document print function) for which the document print function can be executed, and instructs the first host OS to activate an OS filer. The OS filer activated in the first environment is the first OS filer, and the first OS filer is, for example, the first file management application corresponding to the first host OS. Note that, similar to the host OS, the OS filer is an OS standard program installed in advance in the information processing apparatus 101 at the time of arrival of the information processing apparatus 101. In other words, the OS filer is an application not installed by a store application serving as an application for installing various applications in the information processing apparatus 101 via the Internet. As described above, data formats for which the document print function can be executed are, for example, a data format corresponding to PDF, a data format corresponding to Microsoft Word, a data format corresponding to Microsoft Excel, and a data format corresponding to Microsoft PowerPoint. Note that the first OS filer is displayed in a form in which it is layered on the screen of the communication application 300 in a window displaying the communication application 300. That is, in displaying the first OS filer, no other window is newly displayed. In a form in which the first OS filer is displayed by another window, if an operation to change the display target window is performed, an operation to the communication application 300 becomes executable even in a state in which the first OS filer is activated. In contrast, in a form in which the first OS filer and the communication application 300 are displayed in the same window, even if an operation to change the display target window is performed in a state in which the first OS filer is activated, the communication application 300 is not operated. However, the form is not limited to this, and a form in which the first OS filer is displayed by a window different from that of the communication application 300 is also possible.

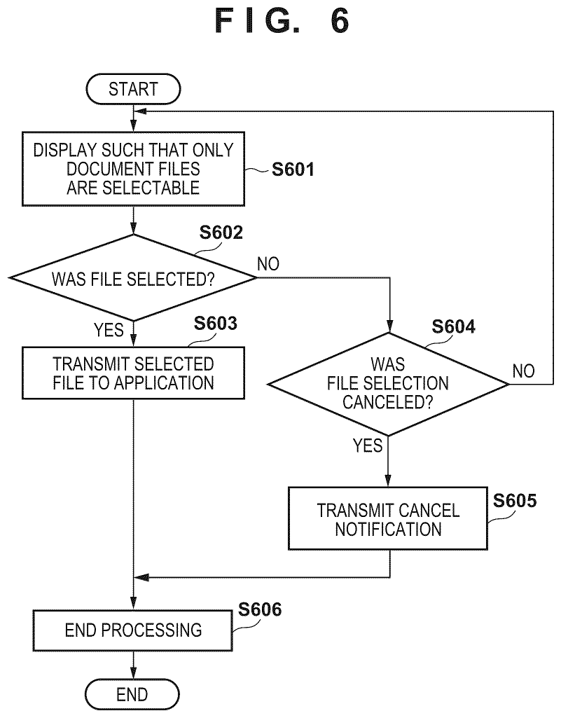

Processing by the first OS filer activated by the processing of step S501 will be explained with reference to FIG. 6. FIG. 6 is a flowchart showing an example of an operation executed by the first OS filer activated by the first OS according to this embodiment. In this flowchart, processing executed by the first OS filer is implemented by, for example, deploying, in the RAM 105, a control program stored in a memory such as the ROM 104 and executing it by the CPU 103.

In step S601, the first OS filer displays, of files stored in the external storage device 106 or the like, only files of a data format (data format printable by the communication application 300 using the document print function) corresponding to the document file designated by the communication application 300 in step S501, so that these files can be selected. That is, in step S601, the first OS filer displays files of data formats other than the data format corresponding to the document file so that these files cannot be selected. For example, the first OS filer executes display control to display files of data formats not corresponding to the document file so that selection of these files cannot be accepted. For example, the first OS may hide or grayscale-display files of data formats not corresponding to the document file. Note that files displayed by the first OS filer are not limited to those stored in the external storage device 106 or the like. For example, files displayed by the first OS filer may be files stored in an external server (not shown) accessible from the information processing apparatus 101. Note that on the screen displayed by the first OS filer, unlike a screen displayed by the second OS filer (to be described later), an operation to display files of data formats other than the data format corresponding to the document file cannot be executed. Thus, a file selected by the user on the file selection screen displayed by the first OS filer always has a data format printable by the communication application 300 using the document print function.

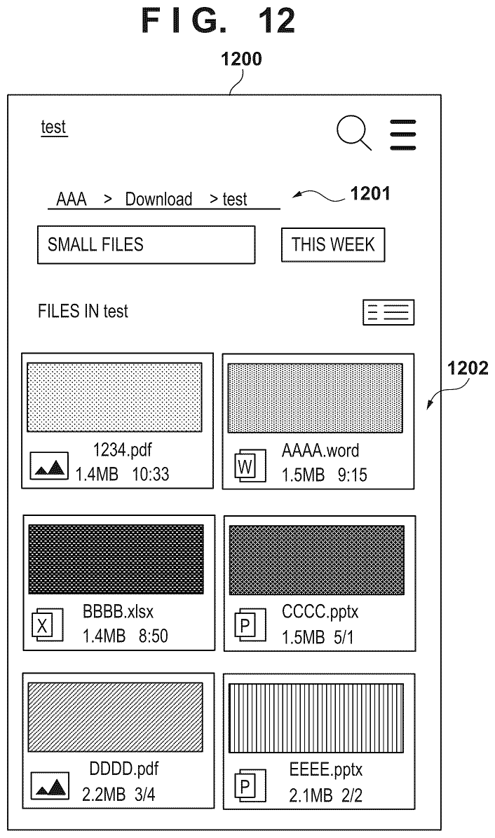

Here, the file selection screen displayed in the processing of step S601 will be explained with reference to FIG. 12. FIG. 12 shows an example of a screen (file selection screen 1200) on which files displayed on the input interface 102 by the first OS filer in step S601 can be selected. On the file selection screen 1200, for example, a file storage location display portion 1201, a file display portion 1202, and the like are displayed.

Information representing the storage location of a file displayed at the file display portion 1202 is displayed at the file storage location display portion 1201. For example, files selectable by the user are displayed at the file display portion 1202. As described above, the first OS filer displays only files of a data format corresponding to the document file designated by the communication application 300 in step S501 so that these files can be selected. Hence, FIG. 12 shows an example in which files of a data format corresponding to PDF are displayed at the file display portion 1202 by the first OS filer. Note that files displayed at the file display portion 1202 are not limited to PDF files. For example, files of data formats corresponding to Microsoft Word, Microsoft Excel, Microsoft PowerPoint, and the like may be displayed. The first OS filer waits until the user selects a file on the file selection screen 1200.

Referring back to FIG. 6, in step S602, the first OS filer determines whether the user has selected a file on the file selection screen 1200. If the first filer determines that a file has been selected, the process advances to step S603. If the first OS filer determines that no file has been selected, the process advances to step S604. More specifically, when the first OS filer accepts an instruction of selection of any file from the user at the file display portion 1202, it may determine that the file has been selected. Also, for example, when the first OS filer does not accept even an instruction of selection of any file at the file display portion 1202, it may determine that no file has been selected. Note that on the file selection screen 1200, only one file can be selected from a plurality of files displayed on the file selection screen 1200. However, the form is not limited to this, and a plurality of files may be selectable on the file selection screen 1200.

In step S603, the first OS filer instructs the first host OS to transmit, to the communication application 300, the file, selection of which has been accepted on the file selection screen 1200.

In step S604, the first OS filer determines whether selection of the file has been canceled on the file selection screen 1200. If the first OS filer determines that selection of the file has been canceled, the process advances to step S605. If the first OS filer determines that selection of the file has not been canceled, the process returns to step S602. More specifically, when the first OS filer accepts an operation to return to a previous screen in a state in which the file selection screen 1200 is displayed, it may determine that selection of the file has been canceled. Also, for example, when the first OS filer has not accepted an operation to return to a previous screen, it may determine that selection of the file has not been canceled.

In step S605, the first OS filer instructs the first OS to transmit, to the communication application 300, a cancel notification that the user has canceled selection of the file.

In step S606, the first OS filer executes end processing to close the file selection screen 1200 in FIG. 12, and the processing in FIG. 6 ends.

Referring back to FIG. 5, in step S502, the communication application 300 obtains predetermined information from the first host OS. The predetermined information is a file, transmission of which is designated by the first OS filer in step S603 of FIG. 6 described above, or a cancel notification, transmission of which is designated by the first OS filer in step S605.

In step S503, the communication application 300 determines whether it has received the file from the first host OS. If the communication application 300 obtains the file from the first host OS in step S502, it determines that the file has been received, and the process advances to step S504. Note that the file obtained here is a file selected on the file selection screen displayed by the OS filer, and the selected file is specified as a printing target file. In contrast, if the communication application 300 obtains the cancel notification from the first host OS in step S502, it determines that no file has been received, and the processing in FIG. 5 ends.

In step S504, the communication application 300 determines whether it is running on a predetermined OS. The predetermined OS is, for example, a guest OS, and a case where the communication application 300 is running on the predetermined OS is equivalent to the above-mentioned second environment. To the contrary, a case where the communication application 300 is not running on the predetermined OS is equivalent to the above-mentioned first environment. That is, this determination is equivalent to processing of determining whether the operating environment of the communication application is the second environment (or the first environment). In step S504, for example, the communication application 300 obtains information of the operating environment using the API of the first host OS, and makes the determination based on the obtained result. Here, a case where the communication application 300 is operating in the first environment is assumed. A case where it is determined in step S504 that the communication application 300 is not running on the predetermined OS, and the process advances to step S506 will be explained below. Note that if the determination result in step S504 is NO, determination in step S505 (to be described later) is not executed. This is because when the determination result in step S504 is NO, a printing target file is selected from files displayed by the first OS filer, and the file selected as the printing target file always has a data format printable by the communication application 300 using the document print function.

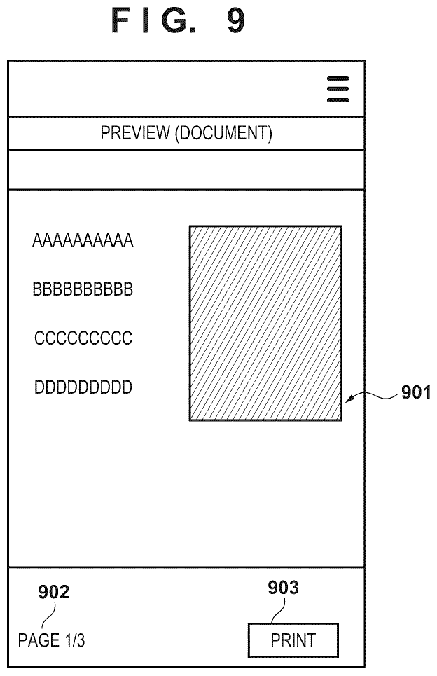

In step S506, the communication application 300 performs display control to display a preview screen on the home screen of the communication application 300. Here, FIG. 9 is referred to. FIG. 9 is a view showing an example of a preview screen displayed by the communication application 300. On the preview screen, for example, a preview portion 901, print page information 902, a print button 903, and the like are displayed. The preview portion 901 is an area where a print preview of a document file selected by the user is displayed. The print page information 902 is, for example, information representing a print count. The print button 903 is an interface capable of accepting an instruction to transmit, to the communication apparatus 151, a print job for executing, by the communication apparatus 151, printing of a document file selected by the user.

Referring back to FIG. 5, in step S507, the communication application 300 determines whether a print instruction has been accepted on the preview screen displayed in step S506. If the print button 903 has been pressed on the preview screen, the communication application 300 advances to step S508. If the print button has not been pressed on the preview screen, the communication application 300 repeats the determination in step S507.

In step S508, the communication application 300 instructs the communication apparatus 151 to execute printing. More specifically, the communication application 300 transmits, to the communication apparatus 151, a print job for executing, by the communication apparatus 151, printing of the document file selected by the user. Then, the processing in FIG. 5 ends.

### Processing when Communication Application Runs in Second Environment

Next, processing when the communication application 300 runs in the second environment will be explained.

In step S501, the communication application 300 designates a data format for which the document print function can be executed, and instructs the guest OS to activate an OS filer. Upon accepting the instruction from the communication application 300, the guest OS transmits, to the Chrome OS serving as the host OS, an instruction similar to the instruction accepted from the communication application. In response to this, the Chrome OS activates an OS filer. The OS filer activated in the second environment is the second OS filer, and the second OS filer is, for example, the second file management application corresponding to the second host OS. As described above, data formats for which the document print function can be executed are, for example, a data format corresponding to PDF, a data format corresponding to Microsoft Word, a data format corresponding to Microsoft Excel, and a data format corresponding to Microsoft PowerPoint. Note that the second OS filer is displayed in a window different from a window displaying the communication application 300. In the second environment, the information processing apparatus 101 can display a plurality of windows in parallel. Hence, when the second OS filer is activated, the window displaying the communication application 300 and the window displaying the second OS filer are displayed in parallel. It may be controlled to invalidate an operation to a screen within the window displaying the communication application 300 in the state in which the two windows are displayed in parallel. This control may be executed by the OS or the communication application 300.

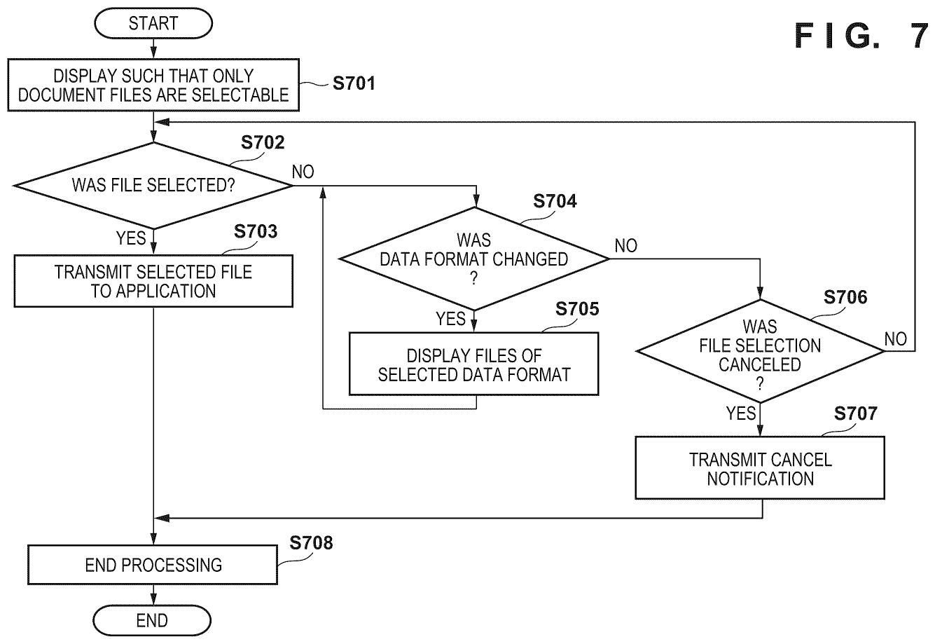

Processing by the second OS filer activated by the processing of step S501 will be explained with reference to FIG. 7. FIG. 7 is a flowchart showing an example of an operation executed by the second OS filer activated by the second host OS as a result of instructing the guest OS by the communication application 300 according to this embodiment. In this flowchart, processing executed by the second OS filer is implemented by, for example, deploying, in the RAM 105, a control program stored in a memory such as the ROM 104 and executing it by the CPU 103.

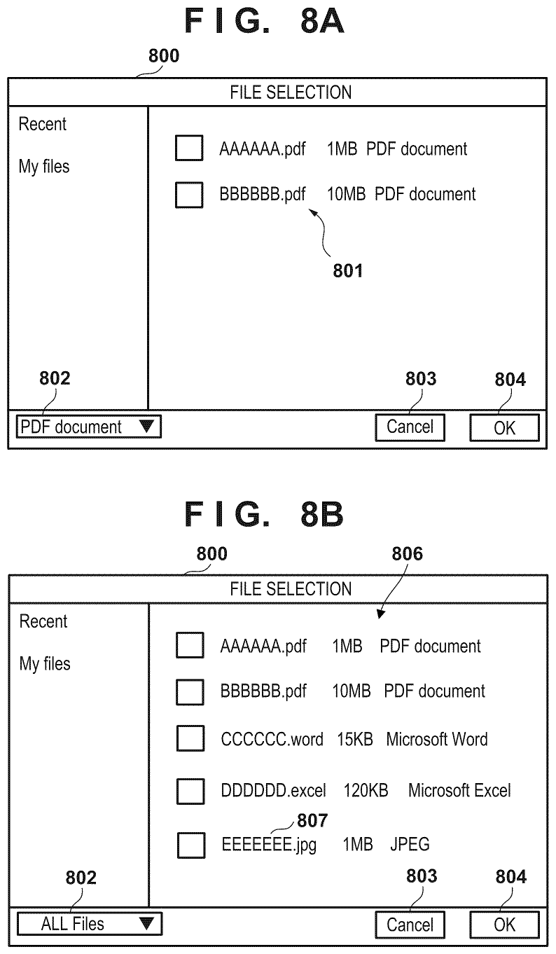

In step S701, the second OS filer displays, of files stored in the external storage device 106 or the like, only files of a data format (data format printable by the communication application 300 using the document print function) corresponding to the document file designated by the communication application 300 in step S501, so that these files can be selected. That is, in step S701, the second OS filer displays files of data formats other than the data format corresponding to the document file so that these files cannot be selected. For example, the second OS filer executes display control to display files of data formats not corresponding to the document file so that selection of these files cannot be accepted. For example, the second host OS may hide or grayscale-display files of data formats not corresponding to the document file. Note that an operation to allow selection of files of data formats other than the data format printable by the communication application 300 using the document print function can be executed on the screen displayed by the second OS filer, which will be described later. When this operation is executed, even files of data formats other than the data format printable by the communication application 300 using the document print function are displayed on the screen displayed by the second OS filer. Hereinafter, FIG. 8A shows a screen displayed in a state in which this operation is not performed, and FIG. 8B shows a screen displayed after this operation is performed.

Here, the screen displayed in the processing of step S701 will be explained with reference to FIG. 8A. FIG. 8A shows an example of a screen (file selection screen 800) on which files displayed on the operation display unit 108 by the second OS filer in step S701 can be selected. On the file selection screen 800, for example, a file display portion 801, a data format interface 802, a cancel button 803, an OK button 804, and the like are displayed.

The file display portion 801 displays, for example, files selectable by the user. Files displayed at the file display portion 801 by the second OS filer may be changed based on, for example, an operation to the data format interface 802 (to be described later). At the file display portion 801, for example, information representing an interface capable of accepting a file selection instruction, a file name, and a file size, information representing the data format of a file, and the like may be displayed. Note that a file displayed first at the file display portion 801 is assumed to be a file of any one of data formats corresponding to the document file designated by the communication application 300 in step S501. When the user wants to change files displayed at the file display portion 801, the user operates the data format interface 802, which will be described below.

The data format interface 802 is, for example, an interface capable of accepting an instruction of selection of the data format of files displayed at the file display portion 801. In this example, the user operates the data format interface 802 to select an item (PDF document) for displaying files of a data format corresponding to PDF. In this example, files of a data format corresponding to PDF are displayed at the file display portion 801 by the second OS filer. The data format interface 802 displayed by the second OS filer is not limited to an item for displaying PDF files. For example, an item for displaying files of a data format corresponding to Microsoft Word, Microsoft Excel, Microsoft PowerPoint, or the like may be selectable.

The cancel button 803 is, for example, an interface capable of accepting an instruction of cancellation of file selection. The OK button 804 is, for example, an interface capable of accepting an instruction of finalization of file selection.

Next, FIG. 8B is referred to. FIG. 8B shows an example of the file selection screen 800 displayed by the second OS filer. The file selection screen 800 shown in FIG. 8B is displayed when, for example, the user operates the data format interface 802 in FIG. 8A to select an item (ALL Files) for displaying files of all data formats. That is, the data format interface 802 displayed by the second OS filer allows selecting an item for displaying files of all data formats, in addition to an item for displaying files of a data format corresponding to the document file. The item of files of all data formats may target, for example, all files stored in the external storage device 106 or the like, or all files stored in an external server (not shown) accessible from the information processing apparatus 101.

A file display portion 806 in FIG. 8B represents an example of files displayed when the user selects ALL Files of the data format interface 802. When the user selects ALL Files, for example, even files of data formats not corresponding to the document file can be displayed at the file display portion 806. FIG. 8B shows an example in which a file 807 of the JPEG format is displayed at the file display portion 801 as a file of a data format not corresponding to the document file.

Referring back to FIG. 7, in step S702, the second OS filer determines whether the user has selected a file on the file selection screen 800 of FIG. 8A. If the second filer determines that a file has been selected, the process advances to step S703. If the second OS filer determines that no file has been selected, the process advances to step S704. More specifically, when the second OS filer accepts an instruction of selection of a file from the user at the file display portion 801 of the file selection screen 800, and accepts an instruction of finalization of the file selection by the OK button 804, it may determine that the file has been selected. Also, for example, when the second OS filer does not accept an instruction of finalization of the file selection by the OK button 804 on the file selection screen 800, it may determine that no file has been selected.

In step S703, the second OS filer instructs the second host OS to transmit, to the communication application 300, the file, selection of which has been accepted on the file selection screen 800. The second host OS executes, to the guest OS, an instruction similar to the instruction accepted from the second OS filer. Then, the guest OS transmits, to the communication application, the file, selection of which has been accepted on the file selection screen 800.

In step S704, the second OS filer determines whether the data format of files displayed on the file selection screen 800 has been changed. If the second OS filer determines that the data format has been changed, the process advances to step S705. On the other hand, if the second OS filer determines that no data format has been changed, the process advances to step S706. More specifically, when the user operates the data format interface 802 to select an item of a data format different from the data format of files displayed at the file display portion 801, the second OS filer may determine that the data format has been changed. To the contrary, when the user does not operate the data format interface 802, the second OS filer may determine that no data format has been changed.

In step S705, the second OS filer displays, on the file selection screen 800, files of the data format selected by the user from the data format interface 802. For example, when the user changes the item from the PDF document item to the ALL Files item at the data format interface 802 in FIG. 8A, a screen as shown in FIG. 8B is displayed by the processing of step S705.

Processing of step S706 is similar to processing of step S604 in FIG. 6, and a description thereof will not be repeated. In step S707, the second OS filer instructs the second host OS to transmit, to the communication application 300, a cancel notification that the user has canceled selection of the file. The second host OS executes, to the guest OS, an instruction similar to the instruction accepted from the second OS filer. Then, the guest OS transmits a cancel notification to the communication application 300.

In step S708, the second OS filer executes end processing to close the file selection screen 800, and the processing in FIG. 7 ends.

Referring back to FIG. 5, in step S502, the communication application 300 obtains predetermined information from the guest OS. More specifically, the predetermined information is a file, transmission of which is designated by the second OS filer in step S703 of FIG. 7 described above, or a cancel notification, transmission of which is designated by the second OS filer in step S706.

In step S503, the communication application 300 determines whether it has received the file from the guest OS. If the communication application 300 has obtained the file from the guest OS in step S502, it determines that it has received the file, and the process advances to step S504. Note that the file obtained here is a file selected on the file selection screen displayed by the OS filer, and the selected file is specified as a printing target file. In contrast, if the communication application 300 has obtained the cancel notification from the guest OS in step S502, it determines that it has not received the file, and the processing in FIG. 5 ends.

In step S504, the communication application 300 determines whether it is running on a predetermined OS. In step S504, for example, the communication application 300 obtains information of the operating environment using the API of the guest OS, and makes the determination based on the obtained result. The determination in this processing is similar to the above-described determination, and a description thereof will not be repeated. Note that a case where the communication application 300 is running in the second environment is assumed here. Thus, a case where it is determined in step S504 that the communication application 300 is running on the predetermined OS, and the process advances to step S505 will be explained.

In step S505, the communication application 300 determines whether the file obtained from the guest OS in step S502 has a data format printable by the communication application 300 using the document print function. If the communication application 300 determines that the file has a data format printable by the communication application 300 using the document print function, the process advances to step S506. To the contrary, if the communication application 300 determines that the file does not have a data format printable by the communication application 300 using the document print function, the process advances to step S509. More specifically, the communication application 300 determines, based on the extension of the file obtained from the second OS, whether the file has a data format corresponding to the document file.

Processes from step S506 to step S508 are similar to those in a case where the communication application 300 runs in the first environment, and a description thereof will not be repeated.

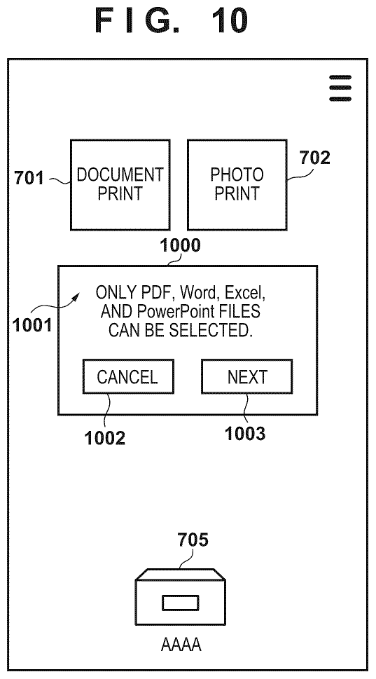

In step S509, the communication application 300 performs predetermined notification processing based on the result of determination in step S508. The predetermined notification processing is notification processing of representing the data format corresponding to the document file. More specifically, in step S509, the communication application 300 displays a predetermined interface on the home screen of the operation display unit 108. Here, FIG. 10 is referred to. FIG. 10 is a view showing an example of a predetermined interface 1000 displayed by the communication application 300 in step S509. At the interface 1000, for example, a notification 1001, a cancel button 1002, a next button 1003, and the like are displayed. The notification 1001 is a notification representing the data format of a printable file. At the notification 1001, for example, a data format corresponding to a document file is displayed. The cancel button 1002 is, for example, an interface capable of accepting an instruction of stop of execution of the document print function. The next button 1003 is, for example, an interface capable of accepting an instruction of reselection of a file. In this manner, even when a file of a data format not corresponding to the communication application 300 is selected, the notification 1001 can prompt the user to select a file of a proper data format. Also, even when the user selects a file of a data format not corresponding to the communication application 300, the user can select a file again with the next button 1003. From the notification 1001, the user can recognize the data format of a document file for which the print job transmission function can be executed.

In step S510, the communication application 300 determines whether an instruction of reselection of a file has been accepted. If the communication application 300 determines that an instruction of reselection of a file has been accepted, the process returns again to step S501. To the contrary, if the communication application 300 determines that an instruction of reselection of a file has not been accepted, the process advances to step S511. More specifically, when the user presses the next button 1003 at the interface 1000 shown in FIG. 10, the communication application 300 determines that an instruction of reselection of a file has been accepted. In contrast, when the user presses the cancel button 1002 or does not perform any operation, the communication application 300 determines that an instruction of reselection of a file has not been accepted.

In step S511, the communication application 300 determines whether a cancel instruction has been accepted. If the communication application 300 determines that a cancel instruction has been accepted, the processing in FIG. 5 ends. If the communication application 300 determines that no cancel instruction has been accepted, the process advances to step S510. More specifically, when the user presses the cancel button 1002 at the interface shown in FIG. 10, the communication application 300 determines that a cancel instruction has been accepted. To the contrary, when the user does not perform any operation, the communication application 300 determines that no cancel instruction has been accepted. That is, in step S511, it is determined whether to stop execution of the document print function.

As described above, according to this embodiment, when the communication application 300 runs in the second environment, the user can select a file of a data format not corresponding to the print job transmission function of a document file. When the user selects a file of a data format not corresponding to the print job transmission function of a document file, the communication application 300 sends a notification representing the data format of a selectable document file. From this notification, even when a file of a data format not corresponding to the communication application 300 is selected, the notification 1001 can prompt the user to select a file of a proper data format.

Note that in this embodiment, the communication application 300 can execute the photo print function as a print function different from the document print function, as described above. The photo print function is executed based on pressing of the photo print button 402 by the user on the home screen. Note that in this embodiment, a data format printable by the communication application 300 using the document print function, and a data format printable by the communication application 300 using the photo print function are different. Also, in this embodiment, items settable on a print setting screen displayed by the communication application 300 for the document print function, and items settable on a print setting screen displayed by the communication application 300 for the photo print function are different. More specifically, items settable on the print setting screen displayed by the communication application 300 for the photo print function include, for example, an item regarding borderless printing and an item regarding sharpness. In contrast, items settable on the print setting screen displayed by the communication application 300 for the document print function include neither an item regarding borderless printing nor an item regarding sharpness. When the document print button 401 is pressed, a file selection screen is displayed to select a printing target file in the document print function. Even the file selection screen displayed here may be displayed by the OS filer. Therefore, characteristic processing (processing equivalent to the processing in FIG. 5) in this embodiment may be executed based on pressing of the photo print button 402 by the user on the home screen. That is, a case where the processing in FIG. 5 is executed based on pressing of the document print button 401 by the user on the home screen has been exemplified above. However, the case where processing equivalent to the processing in FIG. 5 is executed is not limited to this. More specifically, when the photo print button 402 is pressed, the communication application 300 may instruct in step S501 the first host OS or the guest OS about a data format (data format printable by the communication application 300 using the photo print function) corresponding to an image file (step S501).

In this embodiment, an example in which when the communication application 300 runs in the second environment, it is determined whether a file selected by the user corresponds to the data format of a document file has been explained. However, it may be determined whether a file selected by the user corresponds to an image file (step S505). For example, when the user selects a file of a data format not corresponding to the image file, the communication application 300 may issue a notification that the file of the data format not corresponding to the image file has been selected (step S509). Note that processing executed upon pressing the photo print button 402 is not limited to this form. For example, an OS filer activated in accordance with the photo print function may be a filer that does not display any file of a data format other than a data format printable by the communication application 300 using the photo print function. That is, a file of a data format printable by the communication application 300 using the photo print function may always be selected on the file selection screen displayed by an OS filer activated in accordance with the photo print function. In this form, determination equivalent to step S505 may not be executed.

### Second Embodiment

The second embodiment will be explained in terms of a difference from the first embodiment. In the first embodiment, a form in which when the communication application 300 runs in the second environment, and it is determined that a file selected by the user has a data format not corresponding to the print job transmission function (document print function in the above description) of a document file, the interface 1000 in FIG. 10 is displayed has been explained. In the second embodiment, a case where a file selected by the user has a data format not corresponding to the print job transmission function of a document file but a data format corresponding to the print job transmission function (photo print function in the above description) of an image file will be explained.

A case where a communication application 300 according to this embodiment runs in the second environment will be explained. In processing of FIG. 5 according to this embodiment, if the communication application 300 determines in step S505 that a file selected by the user is not a file for which the print job transmission function of a document file can be executed, the following determination may be made.

For example, the communication application 300 may determine whether a file selected by the user has a data format for which the print job transmission function of an image file can be executed. More specifically, the communication application 300 may make a determination based on the extension of the file selected by the user. As described above, data formats for which the print job transmission function of an image file can be executed are a data format corresponding to JPEG, a data format corresponding to GIF, a data format corresponding to PNG, and a data format corresponding to BMP. If the communication application 300 determines that the file selected by the user does not have a data format for which the print job transmission function of an image file can be executed, the process may advance to step S509 to display an interface 1000 in FIG. 10 described above on the home screen. In contrast, if the communication application 300 determines that the file selected by the user has a data format for which the print job transmission function of an image file can be executed, it may perform notification processing representing that the file selected by the user is an image file. The notification processing according to this embodiment will be explained below.

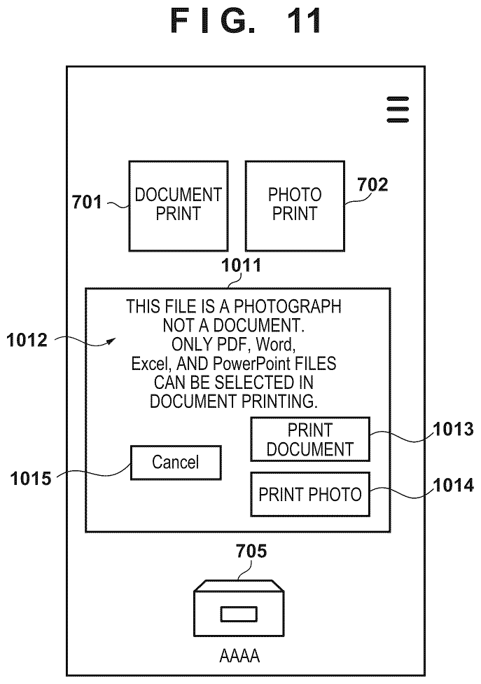

FIG. 11 is referred to. FIG. 11 is a view for explaining notification processing executed by the communication application 300 according to this embodiment. As shown in FIG. 11, an interface 1011 capable of executing the print job transmission function of an image file is notified on the home screen of the communication application 300. At the interface 1011, a notification 1012, a document print button 1013, a photo print button 1014, a cancel button 1015, and the like are displayed.

The notification 1012 includes, for example, a notification that a file selected by the user is not a document file but an image file, and a notification representing a data format corresponding to the print job transmission function of a document file. From the notification 1012 notified on the home screen, the user can recognize that the selected file is a file corresponding to photo printing. In addition, the user can recognize a data format for which the print job transmission function of a document file can be executed. That is, the user friendliness when the user uses the communication application 300 can be improved.

The document print button 1013 is an interface capable of accepting an instruction of reselection of a file. For example, when the user presses the document print button 1013, the communication application 300 may execute processing of step S501. That is, the document print button 1013 is regarded as a button for activating again the second OS filer to execute the print job transmission function of a document file.

The photo print button 1014 is an interface capable of accepting an instruction of display of a print preview of an image file selected by the user. For example, when the user presses the photo print button 1014, the communication application 300 may execute processing of step S501 or execute processing of step S506. The cancel button 1015 is similar to the cancel button 1002 in FIG. 10 described above, and a description thereof will not be repeated.

As described above, according to this embodiment, when a file selected by the user has a data format not corresponding to the print job transmission function of a document file but corresponding to the print job transmission function of an image file, an interface capable of executing the print job transmission function of an image file is displayed. Even when the user selects a file of a data format not corresponding to the print job transmission function of a document file, the user can recognize that the selected file is a file corresponding to photo printing. This improves the user friendliness.

The present invention is not limited to the above embodiments, and various changes and modifications can be made without departing from the spirit and scope of the present invention. Therefore, to apprise the public of the scope of the present invention, the following claims are made.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-175552, filed Oct. 10, 2023, which is hereby incorporated by reference herein in its entirety.

What is claimed is:

1. A non-transitory computer-readable storage medium storing a program, which is able to operate on operating system, configured to cause a computer to execute a method, the method comprising: causing a computer of a first information processing apparatus having a first operating environment on a first OS running as a host OS but not on a guest OS to execute
executing processing for causing a first file management program corresponding to the first OS to display a first file selection screen, and
executing predetermined processing based on a file selected on the first file selection screen; and
causing a computer of a second information processing apparatus having a second operating environment on a second OS running as the host OS and on the guest OS to execute
executing processing for causing a second file management program corresponding to the second OS to display a second file selection screen,
in a case where a data format of a file selected on the second file selection screen is not a predetermined data format, executing predetermined notification processing that is notification processing based on a fact that the data format of the file selected on the second file selection screen is not the predetermined data format, and is notification processing of displaying a notification screen representing that which data format is the predetermined data format, and
in a case where the data format of the file selected on the second file selection screen is the predetermined data format, executing processing based on a file selected on the second file selection screen.

2. The medium according to claim 1, wherein the method further comprises designating the predetermined data format in the processing for causing the first file management program to display the first file selection screen in the executing processing for causing the first file management program corresponding to the first OS to display the first file selection screen, and
in the executing processing for causing the first file management program corresponding to the first OS to display the first file selection screen, a file of a data format other than the predetermined data format is displayed not to be selectable on the first file selection screen.

3. The medium according to claim 2, wherein in the executing processing for causing the second file management program corresponding to the second OS to display the second file selection screen, even a file of a data format other than the predetermined data format is displayed to be selectable on the second file selection screen.

4. The medium according to claim 3, wherein the method further comprises designating the predetermined data format in the processing for causing the second file management program to display the second file selection screen in the executing processing for causing the second file management program corresponding to the second OS to display the second file selection screen,
in the executing processing for causing the second file management program corresponding to the second OS to display the second file selection screen, only a file of at least one data format out of the designated predetermined data format is displayed based on execution of the processing, and
in a case where a predetermined operation is performed on the second file selection screen, a file of a data format other than the predetermined data format is displayed to be selectable on the second file selection screen.

5. The medium according to claim 1, wherein the notification screen includes an area for executing again the processing for causing the second file management program to display the second file selection screen.

6. The medium according to claim 1, wherein the predetermined data format is a data format corresponding to a first function of the program, and
the predetermined notification processing includes processing of, in a case where the file selected on the second file selection screen has not the predetermined data format but a data format corresponding to a second function of the program, displaying a screen including an interface capable of executing the second function.

7. The medium according to claim 6, wherein in a case where the interface capable of executing the second function is operated, a preview screen for printing by the second function the file selected on the second file selection screen is displayed.

8. The medium according to claim 6, wherein the data format corresponding to the second function includes at least one of a data format corresponding to Joint Photographic Experts Group (JPEG), a data format corresponding to Graphics Interchange Format (GIF), a data format corresponding to Portable Network Graphics (PNG), and a data format corresponding to Microsoft Windows Bitmap Image (BMP).

9. The medium according to claim 6, wherein the first function is a function for printing a document file, and the second function is a function for printing an image file.

10. The medium according to claim 1, wherein the processing based on the file selected on the first file selection screen is processing of displaying a preview screen for printing the file selected on the first file selection screen, and
the processing based on the file selected on the second file selection screen is processing of displaying a preview screen for printing the file selected on the second file selection screen.

11. The medium according to claim 10, wherein the processing based on the file selected on the first file selection screen is processing of transmitting, to a printing apparatus, a print job for causing the printing apparatus to print the file selected on the first file selection screen, and
the processing based on the file selected on the second file selection screen is processing of transmitting, to the printing apparatus, a print job for causing the printing apparatus to print the file selected on the second file selection screen.

12. The medium according to claim 1, wherein in the second operating environment, whether the data format of the file selected on the second file selection screen is the predetermined data format is determined, and
in the first operating environment, whether the data format of the file selected on the first file selection screen is the predetermined data format is not determined.

13. The medium according to claim 1, wherein the host OS in the first environment is an Android OS, the host OS in the second operating environment is a Chrome OS, and the guest OS in the second operating environment is a virtual Android OS.

14. The medium according to claim 13, wherein determining whether an environment where the program runs is the second operating environment is further executed, and
whether to execute the predetermined notification processing is controlled based on a determination result in the determining.

15. The medium according to claim 1, wherein the predetermined data format includes at least one of a data format corresponding to Portable Document Format (PDF), a data format corresponding to Microsoft Word, a data format corresponding to Microsoft Excel, and a data format corresponding to Microsoft PowerPoint.

16. The medium according to claim 1, wherein the method further comprises causing the computer of the second information processing apparatus to further execute displaying a first area where an operation for executing a first function for printing a document file is accepted, and a second area where an operation for executing a second function for printing an image file is accepted,
in a case where the operation for executing the first function is accepted in the first area and in a case where the operation for executing the second function is accepted in the second area, the processing for causing the second file management program to display the second file selection screen is executed,
in a case where the operation for executing the first function is accepted in the first area, the predetermined data format is a data format corresponding to the first function,
in a case where the operation for executing the second function is accepted in the second area, the predetermined data format is a data format corresponding to the second function, and
the data format corresponding to the first function and the data format corresponding to the second function are different.

17. The medium according to claim 16, wherein the notification screen displayed in a case where a data format of a file selected on the second file selection screen displayed in the case where the operation for executing the first function is accepted in the first area is not the predetermined data format, and the notification screen displayed in a case where a data format of a file selected on the second file selection screen displayed in the case where the operation for executing the second function is accepted in the second area is not the predetermined data format are different.

18. The medium according to claim 1, wherein the method further comprises causing the computer of the second information processing apparatus to further execute displaying a first area where an operation for executing a first function for printing a document file is accepted, and a second area where an operation for executing a second function for printing an image file is accepted,
in a case where the operation for executing the first function is accepted in the first area, the processing for causing the second file management program to display the second file selection screen is executed, and
in a case where the operation for executing the second function is accepted in the first area, the processing for displaying a selection screen on which data other than data of a data format corresponding to the second function is not displayed is executed.

19. The medium according to claim 1, wherein the program is an application program.

20. A method of controlling a first information processing apparatus having a predetermined program runnable on an operating system (OS) and having a first operating environment on a first OS running as a host OS but not on a guest OS, and a second information processing apparatus having the predetermined program and having a second operating environment on a second OS running as the host OS and on the guest OS, the method comprising:
executing, by the predetermined program in the first information processing apparatus, processing for causing a first file management program corresponding to the first OS to display a first file selection screen;
executing, by the predetermined program in the first information processing apparatus, predetermined processing based on a file selected on the first file selection screen;
executing, by the predetermined program in the second information processing apparatus, processing for causing a second file management program corresponding to the second OS to display a second file selection screen;
in a case where a data format of a file selected on the second file selection screen is not a predetermined data format, executing, by the predetermined program in the second information processing apparatus, predetermined notification processing that is notification processing based on a fact that the data format of the file selected on the second file selection screen is not the predetermined data format, and is notification processing of displaying a notification screen representing that which data format is the predetermined data format; and
in a case where the data format of the file selected on the second file selection screen is the predetermined data format, executing, by the predetermined program in the second information processing apparatus, processing based on a file selected on the second file selection screen.
